(19) United States
(12) Patent Application Publication
(10) Pub. No.: US 2021/0129033 A1
(43) Pub. Date: May 6, 2021

(54) SPECTATOR FEEDBACK TO GAME PLAY

(71) Applicant: Sony Interactive Entertainment Inc., Tokyo (JP)

(72) Inventor: Yuichiro Nakamura, San Mateo, CA (US)

(21) Appl. No.: 16/670,406

(22) Filed: Oct. 31, 2019

(51) Int. Cl. A63F 13/86; A63F 13/61; A63F 13/67; G06K 9/00

(52) U.S. Cl. CPC A63F 13/86; G06K 9/00335; A63F 13/67; A63F 13/61

(57) ABSTRACT

Graphic information pertaining to the interests and other attributes of spectators of a computer simulation is presented to players of the simulation. Similar information may be presented to the spectators.

### FIELD

The application relates generally to technically inventive, non-routine solutions that are necessarily rooted in computer technology and that produce concrete technical improvements.

### BACKGROUND

As understood herein, computer simulations such as computer games not only are played by gamers, but also may be watched by spectators. As also understood herein, spectating computer simulations may be made more interesting an absorbing were bored spectators to be “shaken up” by the simulation itself upon detection of ennui. Further, present principles understand that information about spectators might be of interest to players of computer simulations.

### SUMMARY

Accordingly, a system includes at least one computer simulation controller and at least one computer simulation source configured to receive input from the computer simulation controller to control presentation of a computer simulation presented on at least one display. The computer simulation source includes at least one processor and at least one storage accessible to the processor and comprising instructions executable by the processor to receive at least a first characteristic of at least a first spectator of a computer simulation. The first spectator is not a player of the computer simulation. The instructions are executable to present on a device associated with at least one player of the computer simulation indication of the first characteristic.

The computer simulation source may include a network server communicating with the computer simulation controller over a computer network. The computer simulation source may include a computer game console communicating directly with the computer simulation controller.

The first characteristic can include an emotion of at least the first spectator, an emulated location of the first spectator in the computer simulation, or both. The indication may include at least one avatar rendered according to the first characteristic, and the avatar may represent plural spectators of the computer simulation.

In another aspect, a system includes at least one computer storage that is not a transitory signal and that includes instructions executable by at least one processor to identify at least a first characteristic of at least a first spectator of a computer simulation. The first spectator is not a player of the computer simulation. The instructions are executable to, based at least in part on the first characteristic, present a suggestion on a device associated with the first spectator to become a player of the simulation, or change a skill level of the simulation, or present on the device a substitute simulation, or present on the device, along with the simulation, at least one advertisement, or any combination thereof.

In examples, the instructions may be further executable to activate an electronic device associated with the spectator based at least in part on the first characteristic. The instructions can be executable to insert an avatar into the simulation representing the spectator based at least in part on the first characteristic. Further, the instructions may be executable to, responsive to the first characteristic, present on the device future play of the simulation.

In another aspect, a method includes identifying at least a first characteristic of a non-playing spectator of a computer simulation and presenting on a display associated with a player of the computer simulation indication of the first characteristic.

The details of the present application, both as to its structure and operation, can best be understood in reference to the accompanying drawings, in which like reference numerals refer to like parts, and in which:

### BRIEF DESCRIPTION OF THE DRAWINGS

FIG. 1 is a block diagram of an example system including an example in accordance with present principles;

FIG. 2 schematically illustrates a computer simulation/e-sports spectator watching a computer simulation being played by others;

FIG. 3 is a schematic diagram of a heat map indicating by simulation region how many spectators are looking at each region;

FIG. 4 is a screen shot of an example user interface (UI) that can be presented on a spectator device indicating regions of interest, with an avatar having an expression and direction of gaze established by the spectators' behavior;

FIG. 5 is a screen shot of an example UI showing focus on a region of interest from FIG. 3;

FIG. 6 is a screen shot of an example UI showing moving focus on a region of interest from FIG. 3;

FIG. 7 is a screen shot of an example UI for presentation on a player display showing information pertaining to where spectators are looking and the emotional states of the spectators;

FIG. 8 is a flow chart of example logic consistent with present principles; and

FIG. 9 is a screen shot of an example UI that can be presented on a spectator device in the event that the spectator is sensed as being bored.

### DETAILED DESCRIPTION

This disclosure relates generally to computer ecosystems including aspects of consumer electronics (CE) device networks such as but not limited to computer simulation networks such as computer game networks as well as standalone computer simulation systems. A system herein may include server and client components, connected over a network such that data may be exchanged between the client and server components. The client components may include one or more computing devices including game consoles such as Sony PlayStation® or a game console made by Microsoft or Nintendo or other manufacturer virtual reality (VR) headsets, augmented reality (AR) headsets, portable televisions (e.g. smart TVs, Internet-enabled TVs), portable computers such as laptops and tablet computers, and other mobile devices including smart phones and additional examples discussed below. These client devices may operate with a variety of operating environments. For example, some of the client computers may employ, as examples, Linux operating systems, operating systems from Microsoft, or a Unix operating system, or operating systems produced by Apple Computer or Google. These operating environments may be used to execute one or more browsing programs, such as a browser made by Microsoft or Google or Mozilla or other browser program that can access web sites hosted by the Internet servers discussed below. Also, an operating environment according to present principles may be used to execute one or more computer game programs.

Servers and/or gateways may include one or more processors executing instructions that configure the servers to receive and transmit data over a network such as the Internet. Or, a client and server can be connected over a local intranet or a virtual private network. A server or controller may be instantiated by a game console such as a Sony PlayStation®, a personal computer, etc.

Information may be exchanged over a network between the clients and servers. To this end and for security, servers and/or clients can include firewalls, load balancers, temporary storages, and proxies, and other network infrastructure for reliability and security. One or more servers may form an apparatus that implement methods of providing a secure community such as an online social website to network members.

As used herein, instructions refer to computer-implemented steps for processing information in the system. Instructions can be implemented in software, firmware or hardware and include any type of programmed step undertaken by components of the system.

A processor may be any conventional general-purpose single- or multi-chip processor that can execute logic by means of various lines such as address lines, data lines, and control lines and registers and shift registers.

Software modules described by way of the flow charts and user interfaces herein can include various sub-routines, procedures, etc. Without limiting the disclosure, logic stated to be executed by a particular module can be redistributed to other software modules and/or combined together in a single module and/or made available in a shareable library.

Present principles described herein can be implemented as hardware, software, firmware, or combinations thereof; hence, illustrative components, blocks, modules, circuits, and steps are set forth in terms of their functionality.

Further to what has been alluded to above, logical blocks, modules, and circuits described below can be implemented or performed with a general purpose processor, a digital signal processor (DSP), a field programmable gate array (FPGA) or other programmable logic device such as an application specific integrated circuit (ASIC), discrete gate or transistor logic, discrete hardware components, or any combination thereof designed to perform the functions described herein. A processor can be implemented by a controller or state machine or a combination of computing devices.

The functions and methods described below, when implemented in software, can be written in an appropriate language such as but not limited to Java, C# or C++, and can be stored on or transmitted through a computer-readable storage medium such as a random access memory (RAM), read-only memory (ROM), electrically erasable programmable read-only memory (EEPROM), compact disk read-only memory (CD-ROM) or other optical disk storage such as digital versatile disc (DVD), magnetic disk storage or other magnetic storage devices including removable thumb drives, etc. A connection may establish a computer-readable medium. Such connections can include, as examples, hard-wired cables including fiber optics and coaxial wires and digital subscriber line (DSL) and twisted pair wires. Such connections may include wireless communication connections including infrared and radio.

Components included in one embodiment can be used in other embodiments in any appropriate combination. For example, any of the various components described herein and/or depicted in the Figures may be combined, interchanged or excluded from other embodiments.

“A system having at least one of A, B, and C” (likewise “a system having at least one of A, B, or C” and “a system having at least one of A, B, C”) includes systems that have A alone, B alone, C alone, A and B together, A and C together, B and C together, and/or A, B, and C together, etc.

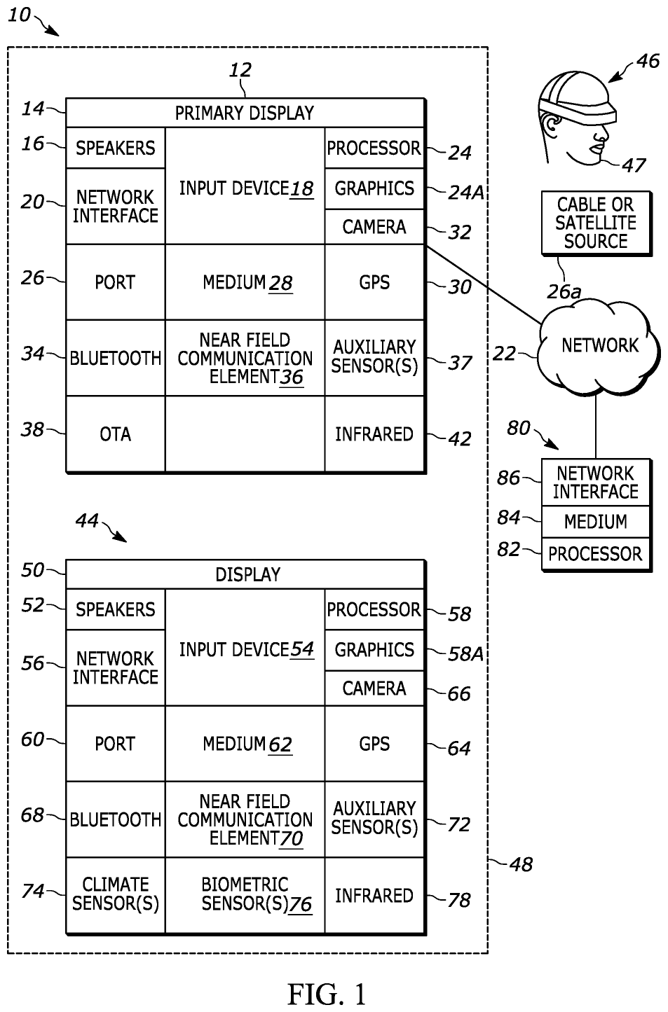

Now specifically referring to FIG. 1, an example system 10 is shown, which may include one or more of the example devices mentioned above and described further below in accordance with present principles. The first of the example devices included in the system 10 is a consumer electronics (CE) device such as an audio video device (AVD) 12 such as but not limited to an Internet-enabled TV with a TV tuner (equivalently, set top box controlling a TV). However, the AVD 12 alternatively may be an appliance or household item, e.g. computerized Internet enabled refrigerator, washer, or dryer. The AVD 12 alternatively may also be a computerized Internet enabled (“smart”) telephone, a tablet computer, a notebook computer, a wearable computerized device such as e.g. computerized Internet-enabled watch, a computerized Internet-enabled bracelet, other computerized Internet-enabled devices, a computerized Internet-enabled music player, computerized Internet-enabled head phones, a computerized Internet-enabled implantable device such as an implantable skin device, etc. Regardless, it is to be understood that the AVD 12 is configured to undertake present principles (e.g. communicate with other CE devices to undertake present principles, execute the logic described herein, and perform any other functions and/or operations described herein).

Accordingly, to undertake such principles the AVD 12 can be established by some or all of the components shown in FIG. 1. For example, the AVD 12 can include one or more displays 14 that may be implemented by a high definition or ultra-high definition “4K” or higher flat screen and that may be touch-enabled for receiving user input signals via touches on the display. The AVD 12 may include one or more speakers 16 for outputting audio in accordance with present principles, and at least one additional input device 18 such as e.g. an audio receiver/microphone for e.g. entering audible commands to the AVD 12 to control the AVD 12. The example AVD 12 may also include one or more network interfaces 20 for communication over at least one network 22 such as the Internet, an WAN, an LAN, etc. under control of one or more processors 24 including. A graphics processor 24A may also be included. Thus, the interface 20 may be, without limitation, a Wi-Fi transceiver, which is an example of a wireless computer network interface, such as but not limited to a mesh network transceiver. It is to be understood that the processor 24 controls the AVD 12 to undertake present principles, including the other elements of the AVD 12 described herein such as e.g. controlling the display 14 to present images thereon and receiving input therefrom. Furthermore, note the network interface 20 may be, e.g., a wired or wireless modem or router, or other appropriate interface such as, e.g., a wireless telephony transceiver, or Wi-Fi transceiver as mentioned above, etc.

In addition to the foregoing, the AVD 12 may also include one or more input ports 26 such as, e.g., a high definition multimedia interface (HDMI) port or a USB port to physically connect (e.g. using a wired connection) to another CE device and/or a headphone port to connect headphones to the AVD 12 for presentation of audio from the AVD 12 to a user through the headphones. For example, the input port 26 may be connected via wire or wirelessly to a cable or satellite source 26a of audio video content. Thus, the source 26a may be, e.g., a separate or integrated set top box, or a satellite receiver. Or, the source 26a may be a game console or disk player containing content that might be regarded by a user as a favorite for channel assignation purposes described further below. The source 26a when implemented as a game console may include some or all of the components described below in relation to the CE device 44.

The AVD 12 may further include one or more computer memories 28 such as disk-based or solid state storage that are not transitory signals, in some cases embodied in the chassis of the AVD as standalone devices or as a personal video recording device (PVR) or video disk player either internal or external to the chassis of the AVD for playing back AV programs or as removable memory media. Also in some embodiments, the AVD 12 can include a position or location receiver such as but not limited to a cellphone receiver, GPS receiver and/or altimeter 30 that is configured to e.g. receive geographic position information from at least one satellite or cellphone tower and provide the information to the processor 24 and/or determine an altitude at which the AVD 12 is disposed in conjunction with the processor 24. However, it is to be understood that another suitable position receiver other than a cellphone receiver, GPS receiver and/or altimeter may be used in accordance with present principles to e.g. determine the location of the AVD 12 in e.g. all three dimensions.

Continuing the description of the AVD 12, in some embodiments the AVD 12 may include one or more cameras 32 that may be, e.g., a thermal imaging camera, a digital camera such as a webcam, and/or a camera integrated into the AVD 12 and controllable by the processor 24 to gather pictures/images and/or video in accordance with present principles. Also included on the AVD 12 may be a Bluetooth transceiver 34 and other Near Field Communication (NFC) element 36 for communication with other devices using Bluetooth and/or NFC technology, respectively. An example NFC element can be a radio frequency identification (RFID) element.

Further still, the AVD 12 may include one or more auxiliary sensors 37 (e.g., a motion sensor such as an accelerometer, gyroscope, cyclometer, or a magnetic sensor, an infrared (IR) sensor, an optical sensor, a speed and/or cadence sensor, a gesture sensor (e.g. for sensing gesture command, etc.) providing input to the processor 24. The AVD 12 may include an over-the-air TV broadcast port 38 for receiving OTA TV broadcasts providing input to the processor 24. In addition to the foregoing, it is noted that the AVD 12 may also include an infrared (IR) transmitter and/or IR receiver and/or IR transceiver 42 such as an IR data association (IRDA) device. A battery (not shown) may be provided for powering the AVD 12.

Still referring to FIG. 1, in addition to the AVD 12, the system 10 may include one or more other CE device types. In one example, a first CE device 44 may be used to send computer game audio and video to the AVD 12 via commands sent directly to the AVD 12 and/or through the below-described server while a second CE device 46 may include similar components as the first CE device 44. In the example shown, the second CE device 46 may be configured as a VR headset worn by a player 47 as shown. In the example shown, only two CE devices 44, 46 are shown, it being understood that fewer or greater devices may be used. For example, principles below discuss multiple players 47 with respective headsets communicating with each other during play of a computer game sourced by a game console to one or more AVD 12.

In the example shown, to illustrate present principles all three devices 12, 44, 46 are assumed to be members of an entertainment network in, e.g., a home, or at least to be present in proximity to each other in a location such as a house. However, present principles are not limited to a particular location, illustrated by dashed lines 48, unless explicitly claimed otherwise.

The example non-limiting first CE device 44 may be established by any one of the above-mentioned devices, for example, a portable wireless laptop computer or notebook computer or game controller, and accordingly may have one or more of the components described below. The first CE device 44 may be a remote control (RC) for, e.g., issuing AV play and pause commands to the AVD 12, or it may be a more sophisticated device such as a tablet computer, a game controller communicating via wired or wireless link with the AVD 12 and/or a game console, a personal computer, a wireless telephone, etc.

Accordingly, the first CE device 44 may include one or more displays 50 that may be touch-enabled for receiving user input signals via touches on the display. The first CE device 44 may include one or more speakers 52 for outputting audio in accordance with present principles, and at least one additional input device 54 such as e.g. an audio receiver/microphone for e.g. entering audible commands to the first CE device 44 to control the device 44. The example first CE device 44 may also include one or more network interfaces 56 for communication over the network 22 under control of one or more CE device processors 58. A graphics processor 58A may also be included. Thus, the interface 56 may be, without limitation, a Wi-Fi transceiver, which is an example of a wireless computer network interface, including mesh network interfaces. It is to be understood that the processor 58 controls the first CE device 44 to undertake present principles, including the other elements of the first CE device 44 described herein such as e.g. controlling the display 50 to present images thereon and receiving input therefrom. Furthermore, note the network interface 56 may be, e.g., a wired or wireless modem or router, or other appropriate interface such as, e.g., a wireless telephony transceiver, or Wi-Fi transceiver as mentioned above, etc.

In addition to the foregoing, the first CE device 44 may also include one or more input ports 60 such as, e.g., a HDMI port or a USB port to physically connect (e.g. using a wired connection) to another CE device and/or a headphone port to connect headphones to the first CE device 44 for presentation of audio from the first CE device 44 to a user through the headphones. The first CE device 44 may further include one or more tangible computer readable storage medium 62 such as disk-based or solid-state storage. Also in some embodiments, the first CE device 44 can include a position or location receiver such as but not limited to a cellphone and/or GPS receiver and/or altimeter 64 that is configured to e.g. receive geographic position information from at least one satellite and/or cell tower, using triangulation, and provide the information to the CE device processor 58 and/or determine an altitude at which the first CE device 44 is disposed in conjunction with the CE device processor 58. However, it is to be understood that another suitable position receiver other than a cellphone and/or GPS receiver and/or altimeter may be used in accordance with present principles to e.g. determine the location of the first CE device 44 in e.g. all three dimensions.

Continuing the description of the first CE device 44, in some embodiments the first CE device 44 may include one or more cameras 66 that may be, e.g., a thermal imaging camera, a digital camera such as a webcam, and/or a camera integrated into the first CE device 44 and controllable by the CE device processor 58 to gather pictures/images and/or video in accordance with present principles. Also included on the first CE device 44 may be a Bluetooth transceiver 68 and other Near Field Communication (NFC) element 70 for communication with other devices using Bluetooth and/or NFC technology, respectively. An example NFC element can be a radio frequency identification (RFID) element.

Further still, the first CE device 44 may include one or more auxiliary sensors 72 (e.g., a motion sensor such as an accelerometer, gyroscope, cyclometer, or a magnetic sensor, an infrared (IR) sensor, an optical sensor, a speed and/or cadence sensor, a gesture sensor (e.g. for sensing gesture command), etc.) providing input to the CE device processor 58. The first CE device 44 may include still other sensors such as e.g. one or more climate sensors 74 (e.g. barometers, humidity sensors, wind sensors, light sensors, temperature sensors, etc.) and/or one or more biometric sensors 76 providing input to the CE device processor 58. In addition to the foregoing, it is noted that in some embodiments the first CE device 44 may also include an infrared (IR) transmitter and/or IR receiver and/or IR transceiver 78 such as an IR data association (IRDA) device. A battery (not shown) may be provided for powering the first CE device 44. The CE device 44 may communicate with the AVD 12 through any of the above-described communication modes and related components.

The second CE device 46 may include some or all of the components shown for the CE device 44. Either one or both CE devices may be powered by one or more batteries.

Now in reference to the afore-mentioned at least one server 80, it includes at least one server processor 82, at least one tangible computer readable storage medium 84 such as disk-based or solid state storage, and at least one network interface 86 that, under control of the server processor 82, allows for communication with the other devices of FIG. 1 over the network 22, and indeed may facilitate communication between servers and client devices in accordance with present principles. Note that the network interface 86 may be, e.g., a wired or wireless modem or router, Wi-Fi transceiver, or other appropriate interface such as, e.g., a wireless telephony transceiver.

Accordingly, in some embodiments the server 80 may be an Internet server or an entire server “farm”, and may include and perform “cloud” functions such that the devices of the system 10 may access a “cloud” environment via the server 80 in example embodiments for, e.g., network gaming applications. Or, the server 80 may be implemented by one or more game consoles or other computers in the same room as the other devices shown in FIG. 1 or nearby.

The methods herein may be implemented as software instructions executed by a processor, suitably configured application specific integrated circuits (ASIC) or field programmable gate array (FPGA) modules, or any other convenient manner as would be appreciated by those skilled in those art. Where employed, the software instructions may be embodied in a non-transitory device such as a CD ROM or Flash drive. The software code instructions may alternatively be embodied in a transitory arrangement such as a radio or optical signal, or via a download over the internet.

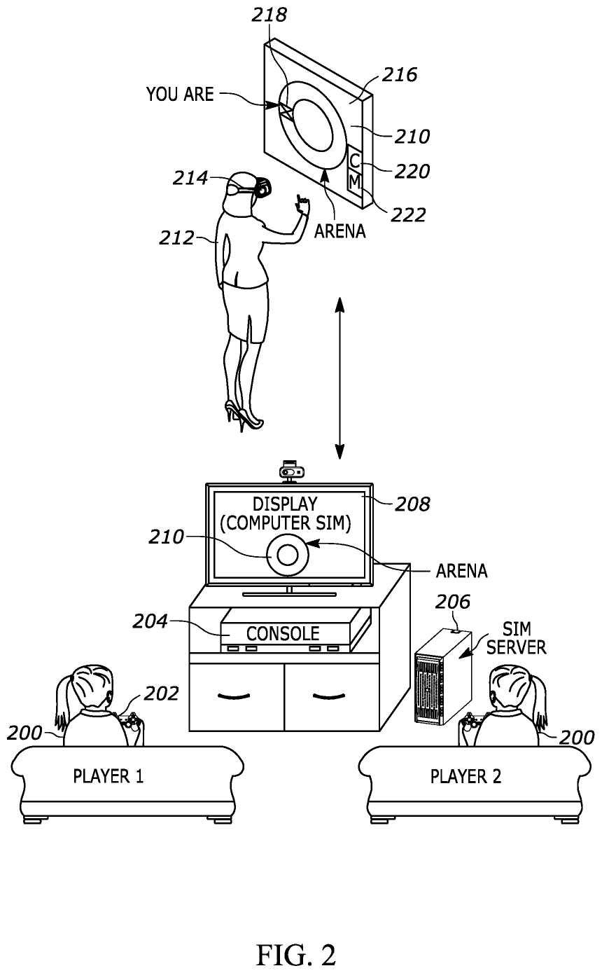

Now referring to FIG. 2, two (or more) computer simulation players 200 are shown playing a computer simulation such as but not limited to a computer game or e-sport by manipulating respective simulation controllers 202 to control a simulation sourced by a simulation console 204 and/or Internet server 206 for audio-video display of the simulation on one or more displays 208. In the example shown, a virtual arena 210 is shown as part of the simulation being presented on the display 208.

Additionally, one or more spectators 212 (only a single spectator shown for clarity) may observe the simulation being presented on the display 208 without being a player of the simulation. The spectator 212 may observe the simulation because the simulation can be provided to a display associated with the spectator, such as a virtual reality (VR) head-mounted display (HMD) 214 and/or a display 216 of a computing device such as a tablet computer, smart phone, etc. The HMD 214 and/or display 216 may include cameras to image the face of the spectator 212 to provide information both for gaze tracking and emotional state of the spectator 212.

In the example shown, the virtual arena 210 is presented on the display 216 along with an indication 218 of where in the virtual arena 210 the spectator 212 is emulated to be located. The device hosting the display 216 may include any of the appropriate components discussed above in relation to FIG. 1, including a camera or other imaging device 220 and a microphone 222.

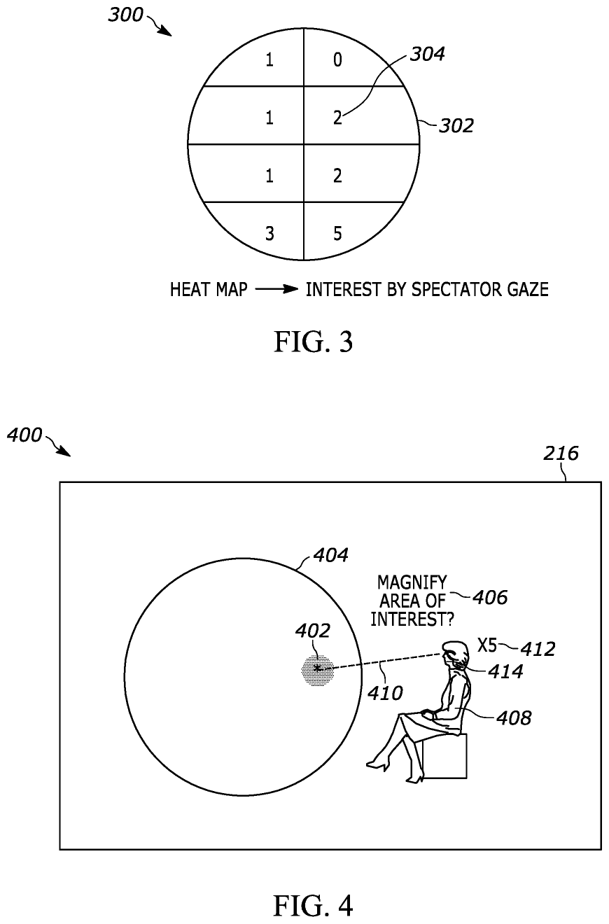

Attention is now drawn to FIG. 3 to illustrate a data structure referred to herein as a “heat map” 300. The heat map 300 indicates, for each of plural regions 302 of the computer simulation, a respective number 304 of spectators viewing the regions. The numbers 304 may be established using eye tracking software on images of the faces of the spectators 212 as imaged by the HMDs or other display devices of the spectators 212 and sent wirelessly to, e.g., the console 204 or server 206 in FIG. 2. In other words, the display devices of the spectators 212 know where the regions of the simulation are being presented on the display devices to the spectators and hence can triangulate, using eye tracking, which region the respective spectator is looking at.

FIG. 4 shows an example user interface (UI) 400 that may be presented on the spectator's display 216 and/or player display 208 as established by the heat map of FIG. 3. In FIG. 4, a “God's eye” view is shown of the entire simulation as the simulated world would be seen from above. As shown, the UI 400 may include an indication 402 (color, symbol, flashing, or other indication) of the region of the simulation 404 being looked at by the most spectators. Multiple indications may be presented in differing colors or other visual qualities to indicate regions of interest from highest to lowest. In FIG. 4, the bottom right region of the simulation 404 is indicated as being most watched in consonance with the lower right numeral “5” in the heat map 300 of FIG. 3.

One or more selectors 406 may be provided in the UI 400 to enable the spectator 212 to magnify the area of most interest as indicated by the indication 402. Also, one or more icons 408 may be shown looking in the emulated direction 410 that the spectators in their emulated locations in the simulation would be looking as indicated by the eye tracking discussed above. Each icon 408 may represent plural spectators as indicated at 412.

Moreover, based on image recognition of the faces of the spectators, the emotional state of each spectator may be determined. In one embodiment the techniques described in the present assignee's co-pending U.S. patent application Ser. No. 16/383,896, incorporated herein by reference, may be used, in which image recognition, audio input of the spectators picked up by, e.g., the microphones 222, and text input as may be provided by the spectators are used to infer the emotional state of the spectators. The emotional state of one of the spectators or an average emotional state of all spectators represented by the icon 408 may establish the animated expression 414 of the icon 408, e.g., the icon 408 may be shown smiling if the emotional state is positive and may be shown frowning if the emotional state is negative.

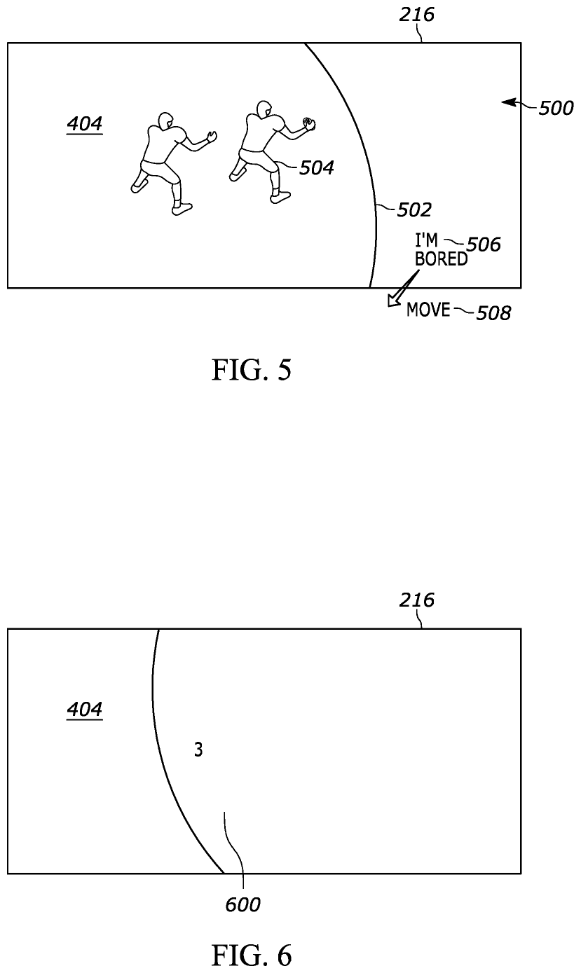

FIG. 5 illustrates a UI 500 that may be presented if the spectator selects the magnify selector 406 in FIG. 4. As shown, the lower right-hand portion 502 of the simulation 404 is enlarged to fill the display. In the example shown, two players 504 are shown, one passing a football to the other, in an e-sports football game.

A selector 506 (labeled “I′m bored” in FIG. 5) may be presented to enable the spectator to pan, as indicated by the arrow 508, to a different region 600 in FIG. 6 of the simulation 404. In the example of FIG. 6, the lower left region is shown. The lower left region remains magnified but in some embodiments selection of the selector 506 may result in returning to the “God's eye” view of FIG. 4.

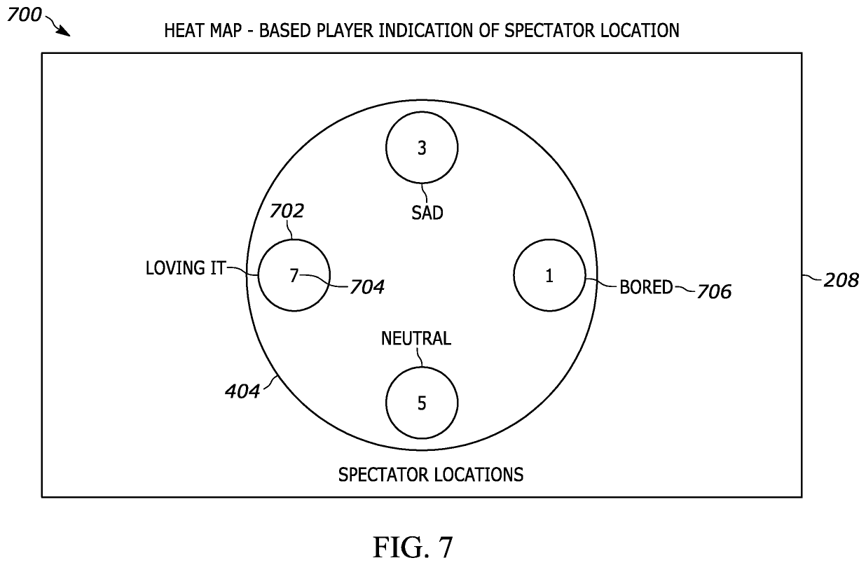

FIG. 7 illustrates a UI 700 that may be presented on the display 208 being viewed by the players 200 in FIG. 2 to give feedback to the players as to the collective sentiment or emotional state of the spectators 212. As shown, the simulation 404 is shown along with emulated locations 702 in the simulation at which spectators are. Moreover, each location 702 may include a numeral 704 indicating how many spectators are emulated to be present at that location. Furthermore, one or more of the locations 702 may include an indication 706 as to the emotional state or average emotional state of spectators at the location. Should a player 200 take action in the simulation that increases interest or improves emotional state of the spectators, the player may be awarded points or trophies.

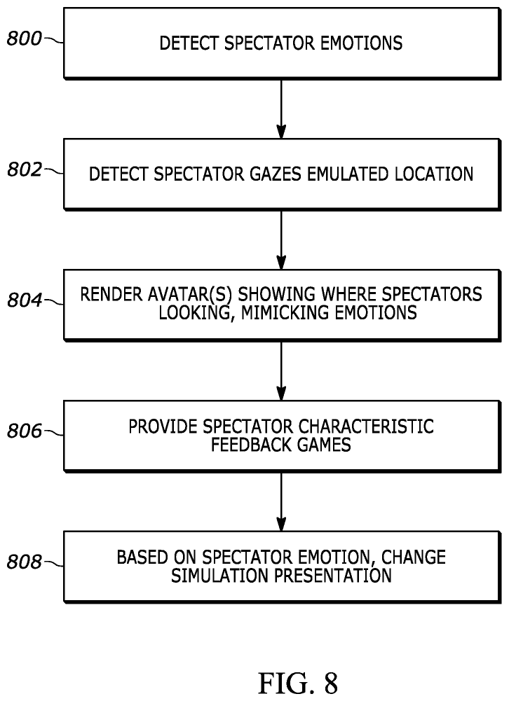

FIG. 8 illustrates logic consistent with present principles that may be executed by any appropriate one or combinations of the devices disclosed herein. Commencing at block 800, spectator emotional state is detected. Moving to block 802, spectator gaze direction is detected as described as well as emulated location of the spectator in the simulation as input, e.g., by the spectator or as automatically assigned to the spectator by the system. Then at block 804 the avatars 408 are rendered consistent with the emotional state and gaze direction.

Furthermore, block 806 indicates that spectator characteristics, e.g., emotional state, cheers, etc. is provided to the devices of the simulation players 200 as feedback as to how the spectators are enjoying the simulation.

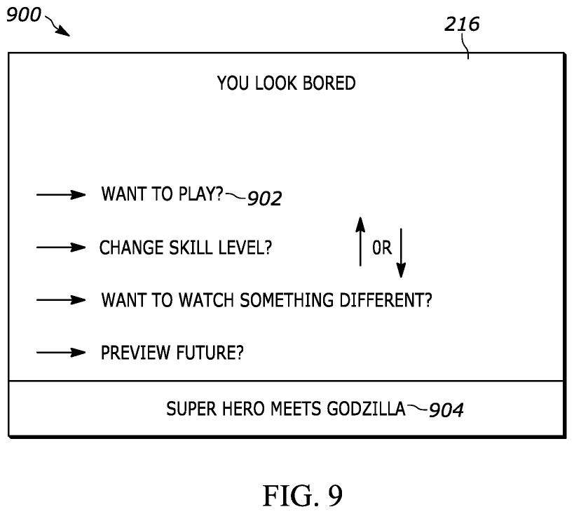

Block 808 indicates that simulation presentation to a particular spectator 212 may be changed at least in part based on the emotional state of the spectator. FIG. 9 illustrates.

As indicated in the UI 900 shown in FIG. 9, one or more suggestions 902, which may be selected by the spectator 212 to invoke the suggestion, may be presented. A first suggestion may be to suggest that the spectator become a player of the simulation. This may be advantageous when the emotional state of the spectator is “bored”. The next selector shown may be to change a skill level of the simulation up or down, while yet a third suggestion would prompt as to whether the spectator would like to view a substitute simulation. Yet a fourth suggestion may be provided to enable the spectator to view future events in the simulation being watched. An advertisement 904 also may be presented to a sad or bored spectator.

It will be appreciated that whilst present principals have been described with reference to some example embodiments, these are not intended to be limiting, and that various alternative arrangements may be used to implement the subject matter claimed herein.

1. A system comprising:
at least one computer simulation controller;
at least one computer simulation source configured to receive input from the computer simulation controller to control presentation of a computer simulation presented on at least one display, the computer simulation source comprising at least one processor programed with instructions to:
receive at least a first characteristic of at least a first spectator of a computer simulation, the first spectator not being a player of the computer simulation;
present on a device associated with at least one player of the computer simulation indication of the first characteristic; and
based at least in part on the first characteristic, present a suggestion on a device associated with the first spectator to become a player of the computer simulation, or change a skill level of the computer simulation, or present on the device a substitute computer simulation, or present on the device, along with the computer simulation, at least one advertisement, or any combination thereof.

2. The system of claim 1, wherein the computer simulation source comprises a network server communicating with the computer simulation controller over a computer network.

3. The system of claim 1, wherein the computer simulation source comprises a computer game console communicating directly with the computer simulation controller.

4. The system of claim 1, wherein the first characteristic comprises an emotion of at least the first spectator.

5. The system of claim 1, wherein the first characteristic comprises an emulated location of the first spectator in the computer simulation.

6. The system of claim 1, wherein the indication comprises at least one avatar rendered according to the first characteristic.

7. The system of claim 6, wherein the avatar represents plural spectators of the computer simulation.

8. A system comprising:
at least one computer storage that is not a transitory signal and that comprises instructions executable by at least one processor to:
identify at least a first characteristic of at least a first spectator of a computer simulation, the first spectator not being a player of the computer simulation; and
based at least in part on the first characteristic, present a suggestion on a device associated with the first spectator to become a player of the computer simulation, or change a skill level of the computer simulation, or present on the device a substitute computer simulation, or present on the device, along with the computer simulation, at least one advertisement, or any combination thereof.

9. The system of claim 8, wherein the instructions are executable to:
based at least in part on the first characteristic, present a suggestion on the device associated with the spectator to become a player of the simulation.

10. The system of claim 8, wherein the instructions are executable to:
based at least in part on the first characteristic, change a skill level of the simulation.

11. The system of claim 8, wherein the instructions are executable to:
based at least in part on the first characteristic, present on the device a substitute simulation.

12. The system of claim 8, wherein the instructions are executable to:
based at least in part on the first characteristic, present on the device, along with the simulation, at least one advertisement.

13. The system of claim 8, wherein the instructions are executable to:
activate an electronic device associated with the spectator based at least in part on the first characteristic.

14. The system of claim 8, wherein the instructions are executable to:
insert an avatar into the simulation representing the spectator based at least in part on the first characteristic.

15. The system of claim 8, wherein the instructions are executable to:
responsive to the first characteristic, present on the device future play of the simulation.

16. A method comprising:
identifying at least a first characteristic of a non-playing spectator of a computer simulation;
presenting on a display associated with a player of the computer simulation indication of the first characteristic;
responsive to the first characteristic indicating lack of interest, presenting on a display associated with the noni-playing spectator an invitation to play in the computer simulation.

17. The method of claim 16, wherein the first characteristic comprises an emotion of at least the first spectator.

18. The method of claim 16, wherein the first characteristic comprises an emulated location of the first spectator in the computer simulation.

19. The method of claim 16, wherein the indication comprises at least one avatar rendered according to the first characteristic.

20. The method of claim 19, wherein the avatar represents plural spectators of the computer simulation.
